(19) United States
(12) Patent Application Publication
(10) Pub. No.: US 2005/0216472 A1
(43) Pub. Date: Sep. 29, 2005

(54) Efficient multicast/broadcast distribution of formatted data

(76) Inventors: David Leon, Irving, TX (US); Igor Danilo Diego Curcio, Tampere (FI); Emre Aksu, Tampere (FI)

Correspondence Address: FOLEY & LARDNER, 321 NORTH CLARK STREET, SUITE 2800, CHICAGO, IL, 60610-4764, US

(21) Appl. No.: 10/813,643

(22) Filed: Mar. 29, 2004

(51) Int. Cl. G06F 17/30

(52) U.S. Cl. 707/10

(57) ABSTRACT

A method, system, device and software code product are disclosed which provide efficient multicast/broadcast distribution of formatted data. Formatted data can comprise metadata and content (media data) and several embodiment of the inventions disclose retransmitting the metadata in order to increase the reliability of the file distribution by increasing the chances that the metadata is received without error. In addition, embodiments of the invention disclose scheduling transmission of data packets of formatted data so that the metadata packets are transmitted at an earlier time location than they occur in the original formatted data file to decrease latency in file playback.

### FIELD OF THE INVENTION

The invention generally relates to multicast and broadcast transmission technology and services, that is, services with at least one data source (or sender) and at least one receiver. More particularly, the present invention relates to distribution of formatted data in multicast and broadcast transmissions.

### BACKGROUND OF THE INVENTION

For one-to-many (i.e., point-to-multipoint) services over systems such as IP multicast, IP datacasting (IPDC) and multimedia broadcast/multicast services (MBMS), file delivery (or discrete media delivery or file download) is an important service. Many of the features for delivering files over point-to-point protocols such as file transfer protocol (FTP) and hypertext transfer protocol (HTTP) are problematic for one-to-many scenarios. In particular, the reliable delivery of files—that is the guaranteed delivery of files—using similar one-to-one (i.e., point-to-point) acknowledgement (ACK) protocols such as transmission control protocol TCP is not feasible.

The Reliable Multicast Transport (RMT) Working Group of the Internet Engineering Task Force (IETF) is in the process of standardizing two categories of error-resilient multicast transport protocols. In the first category, reliability is implemented through the use of (proactive) forward error correction (FEC), that is, by sending a certain amount of redundant data that can help a receiver in reconstructing erroneous data. In the second category, receiver feedback is used in order to implement reliable multicast transport. Asynchronous Layered Coding (ALC, RFC 3450) is a protocol instantiation belonging to the first category, while the NACK-Oriented Reliable Multicast (NORM) protocol presents an example of the second category. The details of ALC and NORM protocols are discussed in more detail in publications entitled “Asynchronous Layered Coding (ALC) Protocol Instantiation” (IETF RFC 3450) and “NACK-oriented Reliable Multicast Protocol” (Internet Draft) prepared by the Working Group of the IETF. The contents of these publications are fully incorporated herein by reference.

Access networks on which these protocols can be used include, but are not limited to, wireless multiple-access networks such as radio access networks of the Universal Mobile Telecommunications Services (UMTS) system, wireless local area networks (WLAN), Digital Video Broadcasting—Terrestrial (DVB-T) networks, Digital Video Broadcasting—Handheld (DVB-H) networks, and Digital Video Broadcasting—Satellite (DVB-S) networks.

File Delivery over Unidirectional Transport (FLUTE) is a one-to-many transport protocol that builds on FEC (RFC 3452) and ALC building blocks. It is intended for file delivery from sender(s) to receiver(s) over unidirectional systems. It has specializations which make it suitable to wireless point-to-multipoint (multicast/broadcast) systems. The details of FLUTE protocol are discussed in more detail in the publication entitled “FLUTE—File Delivery over Unidirectional Transport” (Internet Draft) prepared by the above-mentioned Working Group of the IETF. The contents of this publication are fully incorporated herein by reference.

Briefly, ALC protocol is a proactive FEC-based scheme that allows receivers to reconstruct mangled packets or packets that have not been received. ALC protocol uses FEC encoding on multiple channels, allowing the sender to send data at multiple rates (channels) to possibly heterogeneous receivers. Additionally, ALC protocol uses a congestion control mechanism to maintain different rates on different channels.

ALC protocol is massively scalable in terms of the number of users because no uplink signalling is required. Therefore, adding additional receivers does not put increased demand on the system. However, ALC protocol is not 100% reliable because reception is not guaranteed, thus it may be generally described as robust, rather than reliable.

NORM, in turn, specifies the use of negative acknowledgement (NACK) messages in order to signal which packets of data (or otherwise defined “data blocks”) that were expected to arrive at the receiver were not received at the receiver (or were received incorrectly). In other words, receivers employ NACK messages to indicate loss or damage of transmitted packets to the sender. Accordingly, a receiver that “missed” some data blocks from a data transmission can send a NACK message to the sender requesting the sender to re-transmit the missed data block or blocks. NORM protocol also optionally allows for the use of packet-level FEC encoding for proactive robust transmissions.

NACK messages are not generally NORM specific, but they can also be used in connection with other protocols or systems, such as FLUTE. An ACK is a response message a receiver sends after receiving one or more data packets to acknowledge they were received correctly. A NACK is a response a receiver sends to the sender about packets that were expected to arrive, but were not received.

Multimedia content delivered through a multicast/broadcast delivery system is generally structured in a so-called file format. For example, in the case of 3GPP (3rd Generation Partnership Project) systems, clients expect to receive a file structured as a 3GP file (Transport end-to-end streaming service; 3GPP file format, see 3GPP TS 26.244). For 3GPP2 systems, clients expect to receive a file structure as a 3G2 file (3GPP2 File Formats for Multimedia Services; 3GPP2 file format, see 3GPP2 C.P0050-0 v.0.9.5). In many cases, the file format of a multimedia file can include formatted data. For example, in addition to media data (content), the file format can also include metadata that can be useful for understanding and using the media data. Various different file types, such as audio files, video files, JPEG files, as well as other image and graphics files, etc., can include metadata. A FLUTE transmission itself can include metadata, in the form of the FLUTE FDT. Metadata can be stored at the beginning, middle, or end of a file and there are even cases when the metadata can be scattered throughout the file (e.g. fragmented 3G2 files).

In a multicast or broadcast environment, data transmission generally occurs in a one-to-many fashion. However, transmissions are not always error free. Loss in a downloaded file can degrade the playback quality at the receiver or may even make the file altogether unusable. Whether the file is usable or not can sometimes depend on what data is lost. For example, packet loss from the metadata portion of a file can, in most cases, cause more problems than packet loss from the media data portion of a file. In fact, packet loss from the metadata portion of a file, in many instances, renders the downloaded file unusable. On the other hand, if a data loss occurs in the media data portion of a file, error concealment techniques can often be used to repair the damage or at least make the file usable. As such, the integrity of metadata during the distribution of formatted data can be much more important than the integrity of media data.

The metadata in a formatted message is often used to decode the content of the message. In many instances, the receiver cannot decode the media data until the entire metadata has been downloaded to the receiver. Once the metadata is received, the receiver can usually begin decoding and playing a media file even before all of the media data has been downloaded. However, metadata is not always near the beginning of a media file. In some cases such as when the metadata is located near the end of the file, the receiver may be forced to wait until nearly the entire file is downloaded before the receiver can begin decoding and playing the media file. This is exacerbated when errors occur in the downloading of metadata and the receiver is forced to request and wait for retransmission of the data from the sender.

If a data transmission is not error free and different receivers are subject to different error rates (for example in MBMS users in different cells may experience different signal quality and, as a consequence, different error rate), there is the problem of providing increased data reliability. Techniques, such as FEC or use of a repair session, can be used to decrease or even eliminate residual data loss.

FEC provides a certain amount of redundancy of transmitted data in order to allow a certain degree of error resilience. Thus, in some circumstances, a receiver may be able to recover lost data through a redundant FEC broadcast and use this recovered data to reconstruct the transmitted file. However, one problem with FEC is that it usually does not provide error free error recovery, or if it does, the cost of full error recovery is a high use of data redundancy, which increases the channel bandwidth requirements.

A repair session (between receiver and sender) can be employed to complement FEC (to reduce or eliminate the residual channel error rate), or can be used alone as the only method for error recovery. A repair session can occur over a point-to-point channel using a separate session. In this case, any receiver that has missed some data during the multicast/broadcast transmission can send NACK requests to the sender to request the retransmission of the missing packets. However, if all the receivers miss at least one data packet, the receivers may simultaneously establish point-to-point connections with the sender causing feedback implosion, i.e., congestion in the network (in uplink direction for the large number of NACKs and in downlink direction for the large number of concurrent re-transmission and network connection requests) and overload of the sender. This situation can be critical when considering for example thousands of users, like the case may be in MBMS networks. In addition, use of a repair session can increase the complexity of the system as, receivers need to be configured to setup individual point-to-point repair sessions to a repair server. Furthermore, the repair session may incur a substantial delay before losses can be repaired at all the receivers. Even after using FEC or point-to-point repair, there may still be residual packet loss of metadata rendering the downloaded file useless.

As such, there is a need for an improved device, system, and method for data repair that is customized to provide efficient repair of formatted data messages in multicast and broadcast environments. There is also a need to provide an improved device, system, and method for rearranging the data in a formatted data message to improve formatted data delivery to the receiver.

### SUMMARY OF THE INVENTION

Various embodiments of systems, methods, devices and computer code products are disclosed according to the present invention. The various embodiments include methods, devices, systems and computer code products for distribution of a formatted data file having metadata and content in a system capable of point-to-multipoint communications. In one embodiment, the formatted data file is transmitted from a sender to a plurality of receivers via a point-to-multipoint session and the metadata is retransmitted from the sender to the plurality of receivers via the point-to-multipoint session. Transmitting the data file can include transmitting the metadata at an earlier time location than they occur in the original file and then transmitting the content with retransmitting of the metadata occurring after transmission of the content. The metadata can be retransmitted multiple times.

In one embodiment, the formatted data file can be transmitted in discrete packets each packet having a Source Block Number (SBN) and an Encoding Symbol Identifier (ESI). Preferably, the sender retransmits packets containing metadata with the same SBN and ESI as the corresponding originally transmitted metadata packets. Alternatively, or in conjunction with this, the formatted data file and the retransmitted metadata can be assigned different Transport Object Identifier (TOI) values.

The plurality of receivers can be informed by the sender that metadata repetition will be supported in the point-to-multipoint session. FEC and point-to-point repair schemes can be used in conjunction with metadata repetition. In addition, latency can be decreased in playback of a formatted data file by identifying all metadata in the formatted data file and transmitting the identified metadata at the beginning of the transmission, before transmission of the content.

### BRIEF DESCRIPTION OF THE DRAWINGS

FIG. 1 is a block diagram illustrating a point-to-multipoint transmission scenario in accordance with one embodiment of the invention;

FIGS. 2A, B, and C are block diagrams illustrating various embodiments of formatted data files according to the present invention;

FIG. 3 is a block diagram of system and receiver device in accordance with one embodiment of the invention;

FIG. 4 is a block diagram illustrating a sender device in accordance with one embodiment of the invention.

### DETAILED DESCRIPTION OF THE PREFERRED EMBODIMENTS

Transmission of a 3GP file has, in the past, assumed reliable transport. However, for newer services, such as MBMS download, unreliable transport of a 3GP file is possible. As such, loss resiliency, has become an issue. This is especially true for files that contain both media data and metadata, such as audio, video, image, and graphics files to name a few. In the distribution of this type of formatted data, reliable delivery of the metadata can become crucial to successful download of a file. One aspect of the subject invention is an efficient way of increasing the probability of successful playback of a file at a receiver by maximizing the likelihood that the file metadata is received without errors. Embodiments of the invention are relatively easy to implement and have a low bandwidth usage.

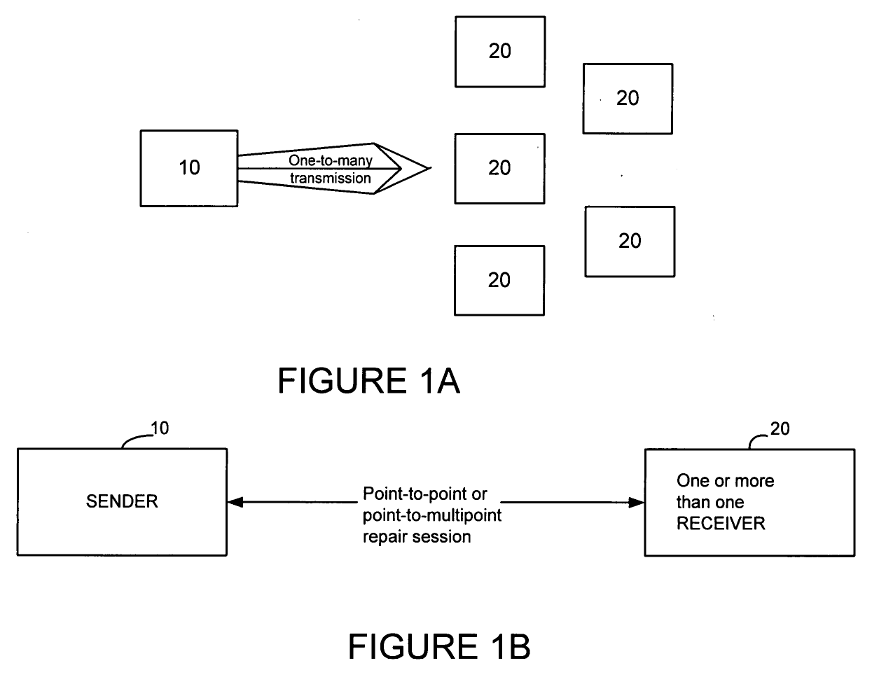

FIG. 1A shows a point-to-multipoint data transmission scenario in accordance with an embodiment of the invention. The sender device 10 can be a server, IP-based device, DVB device, GPRS (or UMTS) device or similar device that may use proactive forward error correction, such as an ALC mechanism and/or FEC mechanism, for sending multicast data blocks (or packets) to receiver devices 20 in a one-to-many fashion.

Data can be transferred from sender 10 to receiver(s) 20 as objects. For instance, a file (e.g. audio file, video file, image file, graphics file, etc.), a JPEG image, and a file slice are all objects. The objects can be sent as a series of data blocks. Each data block can have a number called a source block number (SBN) or similar identifier, which can be used to identify each block. Blocks can be represented by a set of encoding symbols. An encoding symbol identifier (ESI) or similar identifier, in turn, can indicate how the encoding symbols carried in the payload of a data packet (or block) were generated from the above-mentioned object (e.g., file).

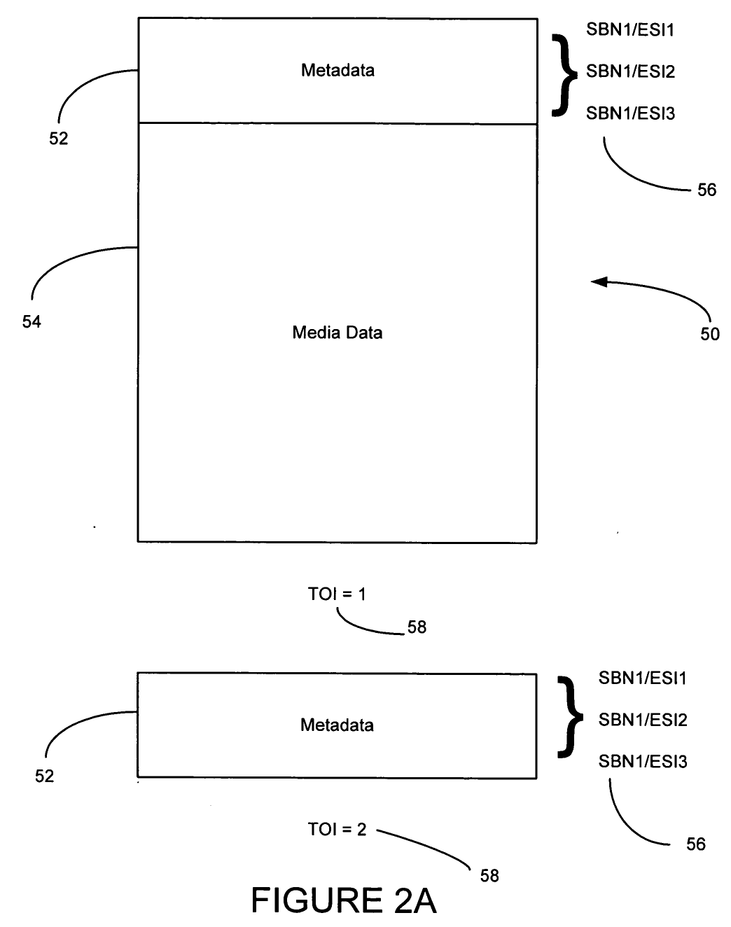

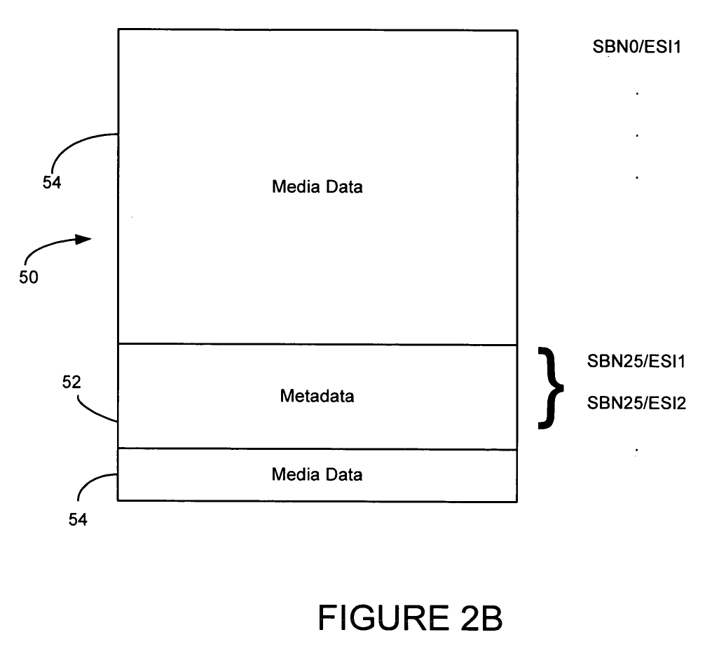

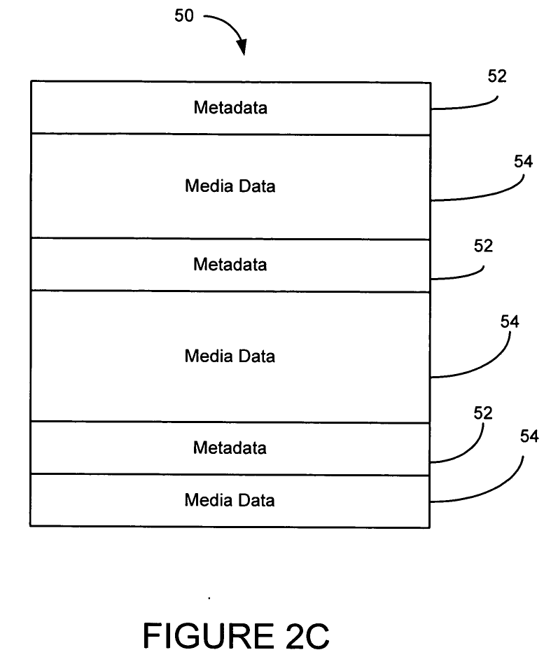

One example of a formatted data file including metadata and media data is illustrated in FIG. 2A. As can be seen in FIG. 2A, the metadata 52 represents only a small percentage of the total file 50, the bulk of the file 50 comprising media data 54. In the embodiment shown in FIG. 2A, the metadata 52 represents a block of information at the beginning of the file 50. However, the metadata 52 can be positioned virtually anywhere in the file 50 and can even be interspersed in blocks within the media data 54. FIG. 2B illustrates one example where the metadata 52 is located near the end of the file 50 and FIG. 2C illustrates one example where the metadata 52 is interspersed in blocks within the media data 54. Some examples of files that include metadata are 3PG files, JPEG files, the FDT of a FLUTE transmission, and multimedia file formats inherited from the ISO Base media file format to name a few. This, of course, is a non-exhaustive list of objects that can contain metadata.

In one embodiment of the present invention, proper delivery of the metadata is maximized by repeating transmission of the metadata, such as, for example, in a FLUTE session. The metadata can be automatically resent without resending the media data. It should be noted that the subject invention is not limited to the FLUTE protocol, but applies to other transport protocols used for multicast/broadcast transmission.

This embodiment has several advantages over an FEC scheme. In a typical case, the metadata can comprise approximately 3% of the total file size. Thus, retransmitting the metadata creates a 3% repetition overhead. A typical FEC scheme with a 3% repetition overhead distributes the overhead over the whole file, while the aforementioned embodiment of the subject invention maximizes delivery of the metadata by allocating the entire repetition overhead to metadata. Another advantage is that there is practically no increase in computational complexity due to this embodiment of the invention. FEC, on the other hand, is computationally intensive.

According to one embodiment of the invention, repetition of the metadata occurs after the entire file has been transmitted. This allows the receivers who have received the metadata without loss to leave the session before the metadata repetition begins. Thus, the receivers can begin playback of the file immediately as they do not need the repeated metadata. Alternatively, repetition of the metadata can happen at any time during a transmission session.

In another embodiment of the invention, multiple repetitions of the metadata can be made. With each repetition, the probability of recovering lost metadata increases. In this embodiment, a receiver can leave the session as soon as it has received all of the metadata without loss. As the metadata is usually only a small part of the total file size, error recovery time is improved over a conventional repetition scheme (carousel) where the entire file is repeated because the time between retransmissions of the metadata alone is less than when the entire file is retransmitted.

In one embodiment of the invention, the sender can make use of the A and B bits, as defined in LCT, RCF 3450, to identify the end of the metadata repetition(s) and the receiver acts accordingly. In one embodiment, the receiver can make use of the FLUTE Source Block Numbers (SBN) and Encoding Symbol Identifiers (ESI) 56 to identify repeated data and to find its correct location in a downloaded file 50. In this embodiment, the sender does not increase the SBN and ESI 56 for the repeated data but instead repeats the metadata 52 with its original SBN and ESI values 56 (see FIG. 2A). The receiver can be configured to ignore packets whose SBN and ESI 56 have already been received. If a different encoding is used (for example a different compression scheme or a FEC scheme is used), the SBN and ESI can be different from those of the original transmission. In an alternative embodiment, different Transport Object Indentifier (TOI) values 58 can be used for the file with media data and the metadata alone in order to distinguish between the message components (see FIG. 2A).

The receiver can be notified by the sender that metadata repetition will be supported. In one embodiment, this can be done via Session Description Protocol (SDP) using an attribute to indicate metadata repetition. One sample syntax for doing so may be:
a=metadata-repetition:(“uri=<”>URI<”>)/<*>))[“,repetitions=”%d]
where URI is defined in RFC 2396. The presence of this attribute in the SDP description (either media or session level) can indicate that the metadata repetition is supported by the sender. If the attribute is present at the session level, the URI can be an absolute URI or simply “*” indicating that the content-base URL will be used and this repetition is valid for all files in the session. If the attribute is present in the media level, the URI can be a relative URL or an absolute URI. The optional repetitions value can be used to define how many times the metadata will be retransmitted. In this case, zero would be an invalid value and no value could default to one retransmission of the metadata.

The metadata repetition technique described herein can also be used with other repair schemes (such as FEC or point-to-point repair). If FEC is used, the sender could repeat the FEC encoded metadata. If, after repetition, some metadata is still missing, receivers could use point-to-point repair, if available, to fill in the missing metadata.

Other variants of these techniques can also be used without repetition of metadata. For example, FEC can be used to allocate more redundancy to the metadata than other data or FEC can be used for the metadata only. If point-to-point repair is available, clients can be restricted to only being allowed to request metadata via point-to-point repair or the sender can be configured to only send metadata via point-to-point repair.

There are various methods and systems for repairing data in a multicast or broadcast system. U.S. patent application entitled “Data Repair” (Ser. No. 10/782,371) filed on Feb. 18, 2004, the contents of which are incorporated fully herein by reference, describes efficient methods for repairing data. U.S. patent application entitled “Data Repair Enhancements for Multicast/Broadcast Data Distribution” (Ser. No. ______) filed currently with this application and assigned to the same assignee, also describes efficient methods for repairing data and is incorporated fully herein by reference.

Another aspect of the invention involves increasing the efficiency of a file download by giving the receiver playback-while-downloading capability. This can be achieved by prescreening the file to be downloaded, identifying and extracting all metadata, and transmitting the metadata at an earlier time location than they occur in the original formatted data file. In a preferred aspect, the transmission of the metadata occurs at the beginning of the transmission, before the media data. If the metadata of a file that is sent via multicast/broadcast is not physically placed in the beginning of the file to transmit (see FIGS. 2B and C), then a sender can reschedule the transmission of the metadata at an earlier time location of the delivery session than they occur in the original formatted data file session, in order to enable the receiver to playback the file with a smaller latency. In one embodiment of the invention using FLUTE, this can be done by changing the transmission schedule of packets, without changing the SBN/ESI structure.

The data repair methods described herein provide distinct advantages when compared to prior art methods. For example, metadata repetition increases the probability that all metadata will be received without error by the receivers with very little extra overhead and nearly no added system complexity. In addition, metadata reorganization and consolidation decreases probability that the a receiver waits for metadata and allows the receiver to initiate playback-while-downloading.

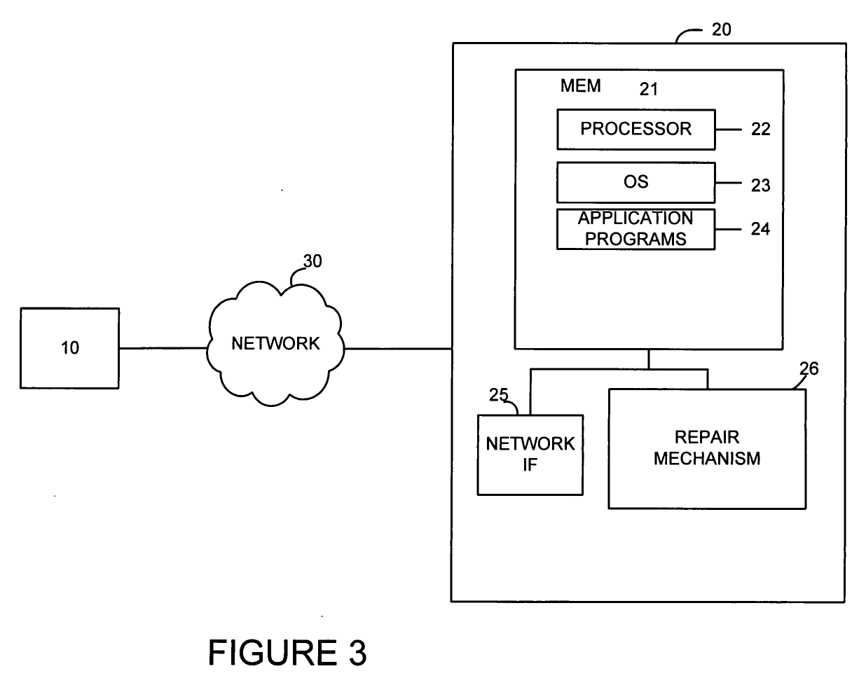

FIG. 3 illustrates one embodiment of a system 5 and receiver device 20 in accordance with the present invention. The system 5 can include a sender device 10, a transmission network 30, e.g., an IP network or another fixed network, a wireless network or a combination of a fixed and wireless (cellular) network, etc., and the receiver device 20. The receiver device 20 can be, for example, a cellular telephone, a satellite telephone, a personal digital assistant, a Bluetooth device, a WLAN device, a DVB device, or other similar wireless device. The receiver 20 can include an internal memory 21, a processor 22, an operating system 23, application programs 24, a network interface 25, and a repair mechanism 26. The internal memory 21 may be configured to accommodate the processor 22, operating system 23 and application programs 24. The repair mechanism 26 can enable the repair procedures in response to missing or mangled data in a data transmission. The receiver device 20 can be capable of communication with the sender device 10 and with other devices via the network interface 25 and the network 30.

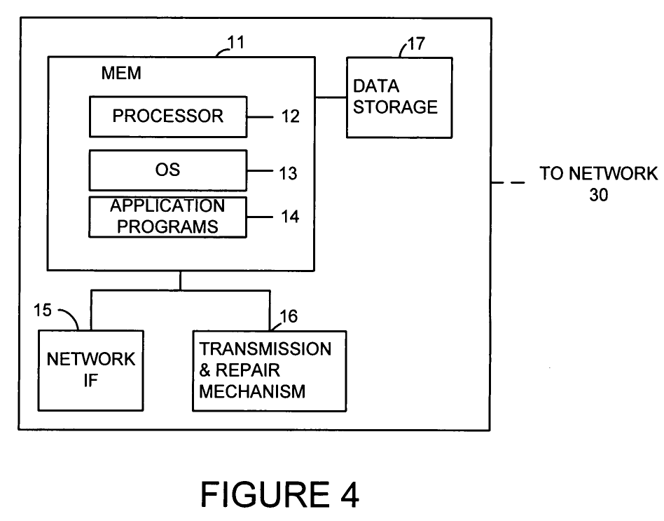

FIG. 4 illustrates one embodiment of a sender device 10 in accordance with the present invention. The sender device 10 can be, for example, a network server or any suitable device intended for file (or media) delivery. The sender device 10 can include internal memory 11, a processor 12, an operating system 13, application programs 14, a network interface 15, a transmission and repair mechanism 16, and a data storage 17. The internal memory 11 can be configured to accommodate the processor 12, operating system 13, and application programs 14. The transmission and repair mechanism 16 can be configured to enable the transmission of data packets to receiver devices 20. Furthermore, it can be setup to enable re-transmission of metadata packets. Data to be sent to receiver devices 20 and data to be re-transmitted can be stored in the data storage 17. Alternatively, data can be stored in a separate device co-located with or outside of the sender device 10. The sender device 10 can be configured to communicate with the receiver device 20 and other devices via the network interface 15 and the network 30.

Procedures relating to repair of missing data can be implemented by software. A computer program product comprising program code stored in the receiver device 20 and run in the processor 22 can be used to implement the procedures at the receiving end of the transmission session, whereas a computer program product comprising program code stored in the sender device 10 and run in the processor 12 can be used to implement the procedures at the transmitting end.

Embodiments of the invention have been illustrated with examples or logical sender/server entitles and receiver units, however, the use of other entities going between for repair requests, and repair responses (if appropriate), are also contemplated and considered within the scope of the subject invention. Such an entity may provide firewall, proxy, and/or authorization services.

While the exemplary embodiments illustrated in the FIGURES and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

1. A method for distribution of a formatted data file having metadata and content in a system capable of point-to-multipoint communications, the method comprising:
transmitting the data file from a sender to a plurality of receivers via a point-to-multipoint session;
retransmitting the metadata from the sender to the plurality of receivers via the point-to-multipoint session;
wherein retransmission of the metadata can occur at any time during the point-to-multipoint session.

2. The method of claim 1, wherein transmitting the data file further comprising transmitting the metadata at an earlier time location in the point-to-multipoint session than it they occur in the formatted data file.

3. The method of claim 1, wherein retransmitting the data file further comprises first transmitting the metadata and then transmitting the content.

4. The method of claim 1, wherein retransmitting the metadata occurs after transmitting the content.

5. The method of claim 1, wherein retransmitting the metadata comprises retransmitting the metadata a plurality of times.

6. The method of claim 1, wherein the formatted data file is transmitted in discrete packets each packet having a Source Block Number (SBN) and an Encoding Symbol Identifier (ESI), wherein the sender retransmits packets containing metadata with the same SBN and ESI as corresponding originally transmitted metadata packets.

7. The method of claim 1, wherein the formatted data file and the retransmitted metadata are assigned different Transport Object Identifier (TOI) values.

8. The method of claim 1, wherein the plurality of receivers are informed by the sender that metadata repetition will be supported in the point-to-multipoint session.

9. The method of claim 8, wherein the sender informs the receivers that metadata repetition will be supported via Session Description Protocol (SDP) using a metadata repetition attribute.

10. The method of claim 9 wherein the metadata repetition attribute is communicated to the receivers as follows: a=metadata-repetition (“uri=<”>URI<”>)/<*>))[“,repetitions=” %d] wherein URI is defined in RFC 2396 and %d is the number of repetitions.

11. The method of claim 1, further comprising using an FEC repair scheme in conjunction with metadata repetition.

12. The method of claim 1, further comprising using a point-to-point repair scheme in conjunction with metadata repetition.

13. A method for distribution of a formatted data file having metadata and content in a system capable of point-to-multipoint communications, the method comprising:
transmitting the data file from a sender to a plurality of receivers via a point-to-multipoint session; and
using FEC to allocate more redundancy to the metadata than is allocated to the content.

14. The method of claim 13 wherein FEC is used for only the metadata.

15. A method for distribution of a formatted data file having metadata and content in a system capable of point-to-multipoint communications, the method comprising:
transmitting the data file from a sender to a plurality of receivers via a point-to-multipoint session; and using point-to-point data repair to repair errors in receipt of metadata wherein the receivers are restricted such that they can request metadata but not content via point-to-point repair.

16. A method for distribution of a formatted data file having metadata and content in a system capable of point-to-multipoint communications, the method comprising:
transmitting the data file from a sender to a plurality of receivers via a point-to-multipoint session; and using point-to-point data repair to repair errors in receipt of metadata wherein the sender is restricted such that it can send metadata but not content via point-to-point repair.

17. A method for decreasing latency in playback of a formatted data file including metadata and content, the method comprising:
identifying all metadata in the formatted data file; and
transmitting the identified metadata to a plurality of receivers at an earlier time location than they occur in the original formatted data file in a point-to-multipoint transmission.

18. The method of claim 17 further comprising transmitting the metadata to the plurality of receivers at the beginning of the point-to-multipoint session and after transmitting all metadata, transmitting the content to the plurality of receivers via the point-to-multipoint transmission session.

19. A system for distributing formatted data files having metadata and content via a point-to-multipoint session, the system comprising:
a sender device; and
a plurality of receiver devices;
wherein the sender device is configured to transmit the formatted data file to the plurality of receiver devices via the point-to-multipoint session; and
wherein the sender device is configured to retransmit the metadata to the plurality of receiver devices via the point-to-multipoint session at any time during the point-to-multipoint session.

20. The system of claim 19 wherein the sender device is further configured to transmit the metadata at an earlier time location in the point-to-multipoint session than it they occur in the formatted data files.

21. The system of claim 19 wherein the sender device is further configured to first transmit the metadata and then transmit the content of the formatted data file.

22. The system of claim 19 wherein the sender device is further configured to retransmit the metadata to the plurality of receiver devices via the point-to-multipoint session a plurality of times.

23. The system of claim 19 wherein the sender device is configured to inform the plurality of receiver devices that metadata repetition will be supported in the point-to-multipoint session.

24. The system of claim 23, wherein the sender device is configured to inform the receivers that metadata repetition will be supported via Session Description Protocol (SDP) using a metadata repetition attribute.

25. The system of claim 24 wherein the metadata repetition attribute is communicated to the receiver devices as follows: a=metadata-repetition (“uri=<”>URI<”>)/<*>))[“,repetitions=” %d] wherein URI is defined in RFC 2396 and %d is the number of repetitions.

26. The system of claim 19 further comprising means for implementing an FEC repair scheme in conjunction with metadata repetition.

27. The system of claim 19 further comprising means for implementing a point-to-point repair scheme in conjunction with metadata repetition.

28. A system for distributing formatted data files having metadata and content via a point-to-multipoint communications session, the system comprising:
a sender device; and
a plurality of receiver devices;
wherein the sender device is configured to use FEC to allocate more redundancy to the metadata than is allocated to the content.

29. The system of claim 28 wherein FEC is used for only the metadata.

30. A system for distributing formatted data files having metadata and content via a point-to-multipoint communications session, the system comprising:
a sender device; and
a plurality of receiver devices;
wherein the sender device is configured to use point-to-point data repair to repair errors in receipt of metadata; and
wherein the receiver devices are restricted such that they can request metadata but not content via point-to-point repair.

31. A system for distributing formatted data files having metadata and content via a point-to-multipoint communications, the system comprising:
a sender device;
a plurality of receiver devices;
wherein the sender device is configured to use point-to-point data repair to repair errors in receipt of metadata;
and wherein the sender device is restricted such that it can send metadata but not content via point-to-point repair.

32. A system for decreasing latency in playback of a formatted data file having metadata and content, the system comprising:
a sender device; and
a plurality of receiver devices;
wherein the sender device is configured for identifying all metadata in a formatted data file and transmitting the identified metadata to the plurality of receiver devices at an earlier time location than they occur in the formatted data file in a point-to-multipoint transmission session.

33. The system of claim 32 wherein the sender device is configured to transmit the metadata to the plurality of receiver devices at the beginning of the a point-to-multipoint transmission session before transmitting the content of the formatted data file to the plurality of receiver device.

34. A sender device for use in a system for distributing formatted data files having metadata and content, the sender device comprising:
means for sending a formatted data file to a plurality of receiver devices via a point-to-multipoint session;
means for retransmitting the metadata of the formatted data file to the plurality of receiver devices via a point-to-multipoint session;
wherein retransmission of the metadata can occur at any time during the point-to-multipoint session.

35. The sender device of claim 34 further comprising means for identifying all metadata in the formatted data file, wherein the means for sending is configured to send all of the metadata to the plurality of receiver devices at an earlier time location than they occur in the formatted data file.

36. The sender device of claim 35 wherein the sender device is configured to transmit all of the metadata to the plurality of receiver devices before beginning to send the content of the formatted data file to the plurality of receiver devices.

37. The sender device of claim 34 wherein the means for retransmitting is configured to retransmit the metadata to the plurality of receiver devices via the point-to-multipoint session a plurality of times.

38. The sender device of claim 34 wherein the sender device further includes means for informing the plurality of receiver devices that metadata repetition will be supported in the point-to-multipoint session.

39. The sender device of claim 38, wherein the sender device is configured to inform the receiver devices that metadata repetition will be supported via Session Description Protocol (SDP) using a metadata repetition attribute.

40. The sender device of claim 39 wherein the metadata repetition attribute is communicated to the receiver devices as follows: a=metadata-repetition (“uri=<”>URI<”>)/<*>))[“,repetitions=” %d] wherein URI is defined in RFC 2396 and %d is the number of repetitions.

41. The sender device of claim 34 further comprising means for implementing an FEC repair scheme in conjunction with metadata repetition.

42. The sender device of claim 34 further comprising means for implementing a point-to-point repair scheme in conjunction with metadata repetition.

43. A sender device for use in a system for distributing formatted data files having metadata and content, the sender device comprising:
means for sending a formatted data file to a plurality of receiver devices via a point-to-multipoint session;
means for implementing FEC to allocate more redundancy to the metadata than is allocated to the content.

44. The sender device of claim 43 wherein the means for implementing is configured to use FEC only for the metadata.

45. A sender device for use in a system for distributing formatted data files having metadata and content, the sender device comprising:
means for sending a formatted data file to a plurality of receiver devices via a point-to-multipoint session;
means for implementing point-to-point data repair to repair errors in receipt of metadata wherein means for sending is restricted such that it can send metadata but not content via point-to-point repair.

46. A computer code product comprising:
computer code configured to:
transmit a formatted data file including metadata and content from a sender device to a plurality of receiver devices via a point-to-multipoint session;
retransmit the metadata to the plurality of receiver devices via the point-to-multipoint session at any time during the point-to-multipoint session.

47. The computer code product of claim 46 further comprising computer code configured to transmit the metadata of the formatted data file at an earlier time location than they occur in the original formatted data file.

48. The computer code product of claim 47 wherein the computer code is configured to transmit the metadata of the formatted data file before transmitting the content of the formatted data file.

49. The computer code product of claim 46 further comprising computer code configured to retransmit the metadata after first transmitting the metadata and content of the formatted data file.

50. The computer code product of claim 46 wherein the computer code is configured to retransmit the metadata a plurality of times.

51. The computer code product of claim 46 wherein the computer code is configured to inform the plurality of receiver devices that metadata repetition will be supported in the point-to-multipoint session.

52. The computer code product of claim 51, wherein the computer code is configured to inform the receiver devices that metadata repetition will be supported via Session Description Protocol (SDP) using a metadata repetition attribute.

53. The method of claim 52 wherein the metadata repetition attribute is communicated to the receiver devices as follows: a=metadata-repetition (“uri=<”>URI<”>)/<*>))[“,repetitions=” %d] wherein URI is defined in RFC 2396 and %d is the number of repetitions.

54. The computer code product of claim 46 wherein the computer code is further configured to implement an FEC repair scheme in conjunction with metadata repetition.

55. The computer code product of claim 46 wherein the computer code is further configured to implement a point-to-point repair scheme in conjunction with metadata repetition.

56. A computer code product comprising:
computer code configured to:
transmit a formatted data file including metadata and content from a sender device to a plurality of receiver devices via a point-to-multipoint session; and
use FEC to allocate more redundancy to the metadata than is allocated to the content.

57. The computer code product of claim 56 wherein FEC is used for only the metadata.

58. A computer code product comprising:
computer code configured to:
transmit a formatted data file including metadata and content from a sender device to a plurality of receiver devices via a point-to-multipoint session; and
use point-to-point data repair to repair errors in receipt of metadata wherein the receiver devices are restricted such that they can request metadata but not content via point-to-point repair

59. A computer code product comprising:
computer code configured to:
transmit a formatted data file including metadata and content from a sender device to a plurality of receiver devices via a point-to-multipoint session; and
use point-to-point data repair to repair errors in receipt of metadata wherein the sender device is restricted such that it can send metadata but not content via point-to-point repair.

60. A computer code product comprising:
computer code configured to:
identify all metadata in a formatted data file including metadata and content; and
transmit the identified metadata at an earlier time location than they occur in the formatted data file in a point-to-multipoint transmission session.

61. The computer code product of claim 60 comprising computer code configured to transmit the identified metadata at the beginning of a point-to-multipoint transmission session before transmission of the content.
